(19) United States
(12) Patent Application Publication
(10) Pub. No.: US 2025/0060693 A1
(43) Pub. Date: Feb. 20, 2025

(54) FIXING DEVICE AND IMAGE FORMING APPARATUS

(71) Applicant: FUJIFILM Business Innovation Corp., Tokyo (JP)

(72) Inventors: Takayuki UKAWA, Kanagawa (JP); Hideki KUGE, Kanagawa (JP); Yoshiki SHIMODAIRA, Kanagawa (JP); Masato YAMASHITA, Kanagawa (JP); Takayuki YAMASHITA, Kanagawa (JP); Yutaka KIUCHI, Kanagawa (JP)

(73) Assignee: FUJIFILM Business Innovation Corp., Tokyo (JP)

(21) Appl. No.: 18/436,545

(22) Filed: Feb. 8, 2024

(30) Foreign Application Priority Data
Aug. 14, 2023 (JP) 2023-132176

(51) Int. Cl. G03G 15/20; G03G 15/16

(52) U.S. Cl. CPC G03G 15/2053; G03G 15/167; G03G 2215/1676; G03G 2215/2003

(57) ABSTRACT

A fixing device includes a fixing roller and a fixing drum that rotates in a rotation direction with a recording medium having an image formed thereon pinched between the fixing roller and the fixing drum, to fix the image onto the recording medium. The fixing drum includes a drum body having a recessed portion formed on an outer circumferential surface thereof, and a sheet-shaped wound member that is wound around the outer circumferential surface and is attached to the drum body in a state in which a portion of the wound member on a downstream side in the rotation direction is bent radially inward of the drum body at a corner portion of the recessed portion.

### CROSS-REFERENCE TO RELATED APPLICATIONS

This application is based on and claims priority under 35 USC 119 from Japanese Patent Application No. 2023-132176 filed Aug. 14, 2023.

### BACKGROUND

### (i) Technical Field

The present invention relates to a fixing device and an image forming apparatus.

### (ii) Related Art

Japanese Unexamined Patent Application Publication No. 2023-31852 discloses a fixing device that includes a first roller on which an elastic layer is formed, and a second roller. A nip portion is formed between the first roller and the second roller in which a recording medium is pinched. The second roller has an axially extending groove on the outer peripheral surface, and does not have an elastic layer.

Japanese Unexamined Patent Application Publication No. 2022-60837 discloses a drum member that includes a cylindrical drum body, a sheet member wound around the drum body, and an elastic adhesive interposed between the drum body and the sheet member.

### SUMMARY

A fixing device that includes a fixing roller and a fixing drum may be contemplated. The fixing drum is rotated in a rotation direction with a recording medium having an image formed thereon pinched between the fixing roller and the fixing drum, to thereby fix the image to the recording medium. The fixing drum may include a drum body having a recessed portion formed on an outer circumferential surface thereof, and a sheet-like wound member wound around the outer circumferential surface.

In the fixing device, if the entirety of the wound member is wound in a state of extending only along the outer peripheral surface of the drum body, the wound member may become loosened when the fixing drum rotates in the rotation direction with the recording medium, having the image formed thereon, pinched between the fixing drum and the fixing roller.

Aspects of non-limiting embodiments of the present disclosure relate to suppression of loosening of the wound member compared to if the entirety of the wound member is wound in a state of extending only along the outer circumferential surface of the drum body.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a fixing roller and a fixing drum that rotates in a rotation direction with a recording medium having an image formed thereon pinched between the fixing roller and the fixing drum, to fix the image onto the recording medium. The fixing drum includes a drum body having a recessed portion formed on an outer circumferential surface thereof, and a sheet-shaped wound member that is wound around the outer circumferential surface and is attached to the drum body in a state in which a portion of the wound member on a downstream side in the rotation direction is bent radially inward of the drum body at a corner portion of the recessed portion.

### BRIEF DESCRIPTION OF THE DRAWINGS

An exemplary embodiment of the present disclosure will be described in detail based on the following figures, wherein:

FIG. 1 is a schematic diagram of an image forming apparatus according to the exemplary embodiment;

FIG. 2 is a perspective view illustrating a configuration around a transfer drum according to the exemplary embodiment;

FIG. 3 is a perspective view illustrating a configuration around a fixing drum according to the exemplary embodiment;

FIG. 4 is a perspective view illustrating grippers according to the exemplary embodiment;

FIG. 5 is a partially enlarged side view of the fixing drum according to the exemplary embodiment;

FIG. 6 is a partially enlarged perspective view of the fixing drum according to the exemplary embodiment; and

FIG. 7 is a side view illustrating an upstream-side attachment portion according to the exemplary embodiment.

### DETAILED DESCRIPTION

Hereinafter, an exemplary embodiment according to the present invention will be described with reference to the drawings.

### <Image Forming Apparatus 10>

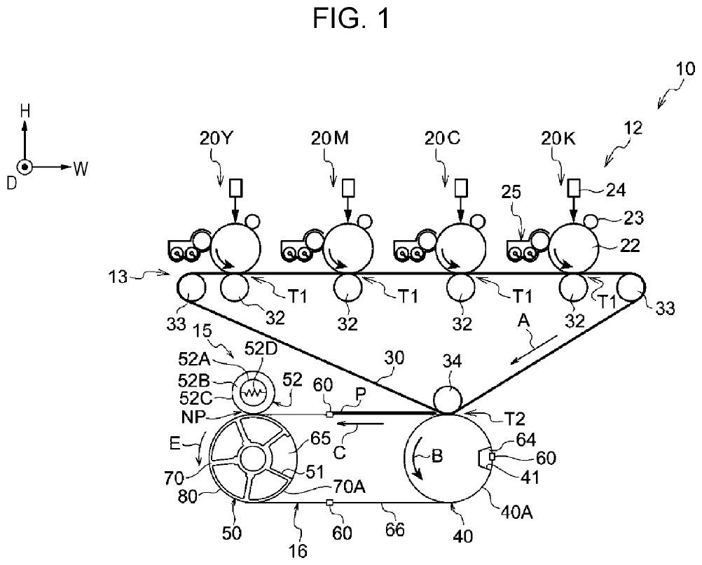

The configuration of the image forming apparatus 10 according to the exemplary embodiment will be described. FIG. 1 is a schematic diagram illustrating the configuration of the image forming apparatus 10 according to the exemplary embodiment. Note that in each of the drawings, an arrow H indicates a vertical direction and a device up-down direction; an arrow W indicates a horizontal direction and a device width direction; and an arrow D indicates a horizontal direction and a device depth direction (device front-rear direction). The dimensional ratios in the H-direction, the W-direction, and the D-direction between the parts illustrated in the drawings may be different from the actual dimensional ratios.

The image forming apparatus 10 illustrated in FIG. 1 forms a toner image (an example of an image) on a recording medium P. Specifically, the image forming apparatus 10 includes an image forming unit 12, a fixing device 15, and a transport mechanism 16. Hereinafter, each unit (the image forming unit 12, the fixing device 15, and the transport mechanism 16) of the image forming apparatus 10 will be described.

### <Image Forming Unit 12>

The image forming unit 12 is a constituent unit that electrophotographically forms a toner image on the recording medium P. Specifically, as illustrated in FIG. 1, the image forming unit 12 includes a toner image forming unit 20 that forms a toner image, and a transfer device 13 that transfers the toner image formed by the toner image forming unit 20 onto the recording medium P.

### <Toner Image Forming Unit 20>

As illustrated in FIG. 1, a plurality of toner image forming units 20 are provided so as to form a toner image for each color. In the exemplary embodiment, the toner image forming units 20 for the total four colors of yellow (Y), magenta (M), cyan (C), and black (K) are provided. In FIG. 1, (Y), (M), (C), and (K) indicate components corresponding to the respective colors.

The toner image forming units 20 of the respective colors have the same configuration, except for the toners to be used. Thus, the parts of the toner image forming unit 20 (K), representing the toner image forming units 20 of the respective colors, are denoted by reference numerals in FIG. 1.

Specifically, the toner image forming unit 20 for each color includes a photoreceptor 22 that rotates in one direction (for example, a counterclockwise direction in FIG. 1). The toner image forming unit 20 for each color includes a charger 23, an exposure device 24, and a developing device 25.

In the toner image forming unit 20 for each color, the charger 23 charges the photoreceptor 22. Further, the exposure device 24 exposes the photoreceptor 22 charged by the charger 23 to form an electrostatic latent image on the photoreceptor 22. The developing device 25 develops the electrostatic latent image formed on the photoreceptor 22 by the exposure device 24, to form a toner image.

### <Transfer Device 13>

The transfer device 13 illustrated in FIG. 1 is a device that transfers the toner image onto the recording medium P. Specifically, the transfer device 13 primarily transfers the toner images on the photoreceptors 22 for the respective colors onto a transfer belt 30, which serves as an intermediate transfer body, in a superimposed manner, and secondarily transfers the superimposed toner images onto the recording medium P. As illustrated in FIG. 1, the transfer device 13 includes the transfer belt 30, primary transfer rollers 32, and a transfer drum 40.

The primary transfer rollers 32 are rollers that transfer the toner images on the photoreceptors 22 of the respective colors onto the transfer belt 30 at primary transfer positions T1 between the photoreceptors 22 and the primary transfer rollers 32. In the exemplary embodiment, a primary transfer electric field is applied between the primary transfer roller 32 and the photoreceptor 22, to thereby transfer the toner image formed on the photoreceptor 22 onto the transfer belt 30 at the primary transfer positions T1.

The transfer belt 30 has an outer peripheral surface onto which the toner images are transferred from the photoreceptors 22 of the respective colors. As illustrated in FIG. 1, the transfer belt 30 has an endless shape, and is wound around the plurality of rollers 33 and an opposing roller 34 so as to form an inverted triangular shape in a frontal view (as viewed in the device depth-direction). The transfer belt 30 circulates in the direction of arrow A when at least one of the plurality of rollers 33 is rotationally driven.

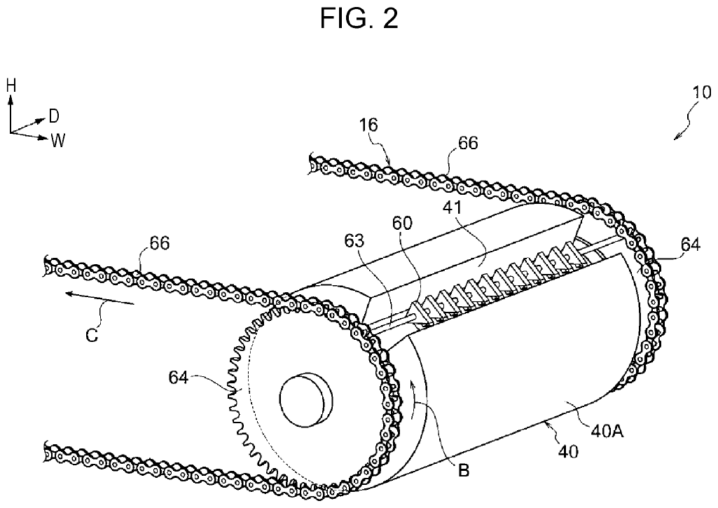

The transfer drum 40 has a function of transferring the toner image transferred onto the transfer belt 30 onto the recording medium P. As illustrated in FIGS. 1 and 2, the transfer drum 40 has a recessed portion 41 formed on an outer peripheral surface 40A thereof, and rotates in a rotation direction B. The recessed portion 41 is elongated along the axial direction of the transfer drum 40, and has a depth along the radial direction of the transfer drum 40.

As illustrated in FIG. 1, the transfer drum 40 is disposed below the transfer belt 30 so as to face the transfer belt 30. Further, the transfer drum 40 is in contact with the transfer belt 30 in a range of the outer peripheral surface 40A extending from the upstream end to the downstream end in the rotation direction of the recessed portion 41.

As illustrated in FIG. 2, a pair of sprockets 64 are provided at both axial ends of the transfer drum 40. The pair of sprockets 64 are disposed coaxially on the transfer drum 40.

The transfer drum 40 is rotationally driven by a drive unit (not illustrated) to rotate in the rotation direction B, thereby rotating in the rotation direction B integrally with the pair of sprockets 64.

In the exemplary embodiment, the transfer belt 30 and the transfer drum 40 transport the recording medium P in a pinched state at the secondary transfer position T2 (see FIG. 1). Then, a secondary transfer electric field is applied between the opposing roller 34 and the transfer drum 40, to thereby transfer the toner images transferred on the transfer belt 30 onto the recording medium P at the secondary transfer position T2. Note that grippers 60 and an attachment member 63 that hold the recording medium P, as will be described later, are accommodated in the recessed portion 41 when passing through the secondary transfer position T2, and thus avoid contact with the transfer belt 30.

### <Fixing Device 15>

The fixing device 15 is a device that fixes the toner image transferred onto the recording medium P by the transfer device 13 to the recording medium P. Specifically, as illustrated in FIG. 1, the fixing device 15 includes a fixing drum 50 and a heating roller 52. The heating roller 52 is an example of a fixing roller.

In the fixing device 15, the heating roller 52 is disposed above the fixing drum 50. The fixing drum 50 has a larger diameter and a larger mass (i.e., moment of inertia) than the heating roller 52. The heating roller 52 includes a heat source 52D, such as a lamp, therein (specifically, inside a body 52A to be described later), and is heated by the heat source 52D.

The fixing drum 50 is a drum member that rotates in a rotation direction E with the recording medium P having the toner image formed thereon pinched between the fixing drum 50 and the heating roller 52, to fix the toner image to the recording medium P. The fixing drum 50 has a recessed portion 51 formed in an outer peripheral surface (specifically, an outer peripheral surface 70A of a drum body 70 to be described later). The recessed portion 51 accommodates the grippers 60 and the attachment member 63, as will be described later. Thus, the grippers 60 and the attachment member 63 can avoid contact with the heating roller 52 when passing through a fixing position NP.

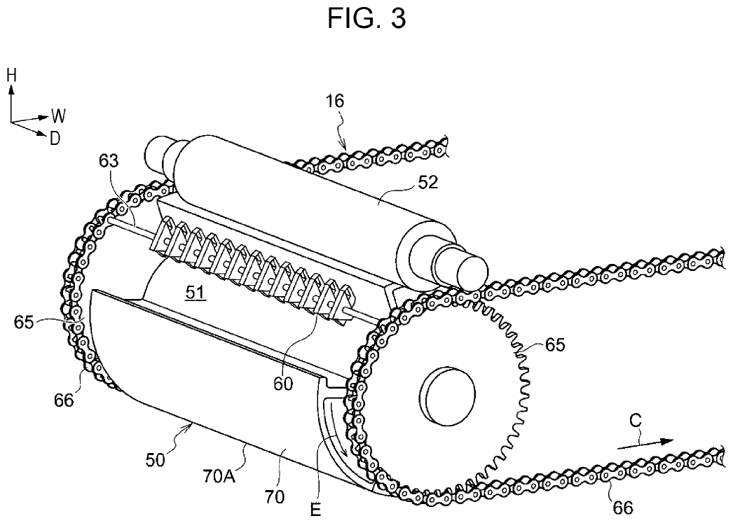

As illustrated in FIG. 3, a pair of sprockets 65 are provided at both axial ends of the fixing drum 50. The pair of sprockets 65 are disposed coaxially on the fixing drum 50. The fixing drum 50 is rotationally driven by a drive unit (not illustrated) to rotate in the rotation direction E, thereby rotating in the rotation direction E integrally with the pair of sprockets 65.

In the fixing device 15, as the recording medium P is transported in a state of being pinched between the heating roller 52 and the fixing drum 50 at the fixing position NP, the recording medium P is heated by the heating roller 52 and is pressed by the heating roller 52 and the fixing drum 50. In this way, the toner image transferred onto the recording medium P is fixed to the recording medium P. Specific configurations of the heating roller 52 and the fixing drum 50 will be described later.

### <Transport Mechanism 16>

The transport mechanism 16 illustrated in FIG. 1 is a mechanism that transports the recording medium P. As illustrated in FIGS. 1 and 2, the transport mechanism 16 includes a pair of chains 66 and the grippers 60. In FIG. 1, one of the pair of chains 66 is illustrated, and the chains 66 and the grippers 60 are illustrated in a simplified manner.

As illustrated in FIG. 1, the pair of chains 66 are formed in an annular shape. As illustrated in FIG. 2, the pair of chains 66 are disposed at an interval in the device depth direction (D-direction in the drawing). Each of the pair of chains 66 is wound around each of the pair of sprockets 64 provided at both axial ends of the transfer drum 40, and around each of the pair of sprockets 65 (see FIG. 3) provided at both axial ends of the fixing drum 50. The transfer drum 40 is rotationally driven in the rotation direction B (direction of arrow B), and the fixing drum 50 is rotationally driven in the rotation direction E. As a result, the chains 66 circulate in a circulating direction C (direction of arrow C).

As illustrated in FIG. 2, the attachment member 63 to which the grippers 60 are attached is stretched between the pair of chains 66 along the device depth direction. A plurality of attachment members 63 are fixed to the pair of chains 66 at predetermined intervals along the circulating direction C of the chains 66.

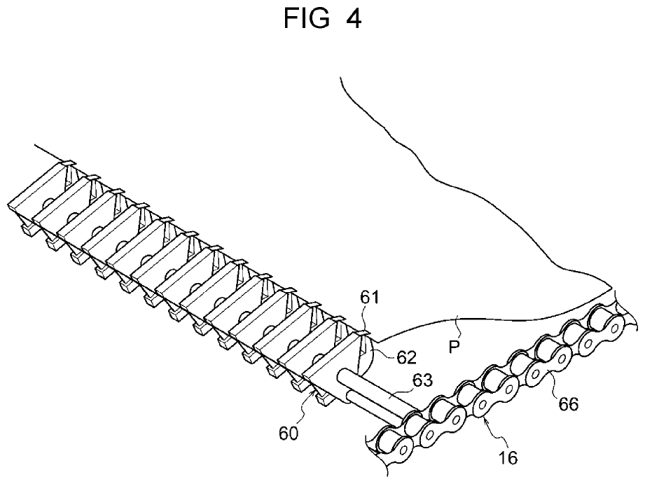

As illustrated in FIG. 2, a plurality of grippers 60 are attached to the attachment member 63 at predetermined intervals along the device depth direction. The grippers 60 function as holding portions to hold the leading end portion of the recording medium P. Specifically, the grippers 60, as illustrated in FIG. 4, each include a pawl 61 and a pawl base 62. The grippers 60 are configured to hold the recording medium P by pinching the leading end portion of the recording medium P between the pawl 61 and the pawl base 62. Note that in the grippers 60, for example, the pawl 61 is pressed against the pawl base 62 by a spring or the like, and the pawl 61 is opened or closed with respect to the pawl base 62 by the action of a cam or the like.

In the transport mechanism 16, the leading end portion of the recording medium P, which is fed from an accommodation unit (not illustrated) for accommodating the recording medium P, is held by the grippers 60, as illustrated in FIG. 4. As the chains 66 circulate in the circulating direction C, the grippers 60 holding the leading end portion of the recording medium P cause the recording medium P to be transported and to pass through the secondary transfer position T2. Next, at the secondary transfer position T2, the transfer drum 40 secondarily transfers the toner images, which have been superimposed and primarily transferred onto the transfer belt 30 at the primary transfer positions T1 for the respective colors, onto the recording medium P at the secondary transfer position T2.

Further, as the chains 66 circulate in the circulating direction C, the grippers 60 holding the leading end portion of the recording medium P transport the recording medium P and cause the recording medium P to pass through the fixing position NP. Then, in the fixing device 15, the recording medium P is pinched between the heating roller 52 and the fixing drum 50 at the fixing position NP, and the image on the recording medium P is fixed to the recording medium.

Note that the grippers 60, when passing through the secondary transfer position T2, are accommodated in the recessed portion 41 formed on the outer circumferential surface of the transfer drum 40, together with the attachment member 63. When passing through the fixing position NP, the grippers 60 are accommodated in the recessed portion 51 formed on the outer circumferential surface of the fixing drum 50, together with the attachment member 63.

### <Heating Roller 52>

As illustrated in FIG. 1, the heating roller 52 includes a cylindrical body 52A, an elastic layer 52A covering the entire periphery of the body 52A, and a release layer 52C covering the entire periphery of the elastic layer 52B.

Here, the elastic layer refers to a rubber layer, a resin layer, or the like having a lower elastic modulus than metal. The elastic layer has a large amount of displacement with respect to force, and is formed of a member whose elastic modulus (Young's modulus) at 25° C. is on the order of several to several hundred megapascals. Specifically, the elastic layer is formed of a member having an elastic modulus of 1 [MPa] or more and 60 [MPa] or less. That is, the elastic layer functions as a deformation layer that deforms to extend along the outer surface of an object when pressed from the object.

### <Fixing Drum 50>

As illustrated in FIGS. 1, 5, and 6, the fixing drum 50 includes the drum body 70 having the recessed portion 51 formed on the outer circumferential surface 70A, and a sheet-shaped wound member 80 wound around the outer peripheral surface 70A of the drum body 70.

In the following description, the rotation direction E of the fixing drum 50 (drum body 70) may be simply referred to as “rotation direction E” or a “downstream side in the rotation direction E”. The opposite side in the rotation direction E may be referred to as an “upstream side in the rotation direction E”. In addition, a radial direction of the fixing drum 50 (drum body 70) may be simply referred to as “the radial direction”. A direction from the center of the fixing drum 50 (drum body 70) toward the outside along the radial direction may be referred to as a “radially outer side”, and the opposite side may be referred to as a “radially inner side”. The axial direction of the fixing drum 50 (drum body 70) may be simply referred to as “the axial direction”.

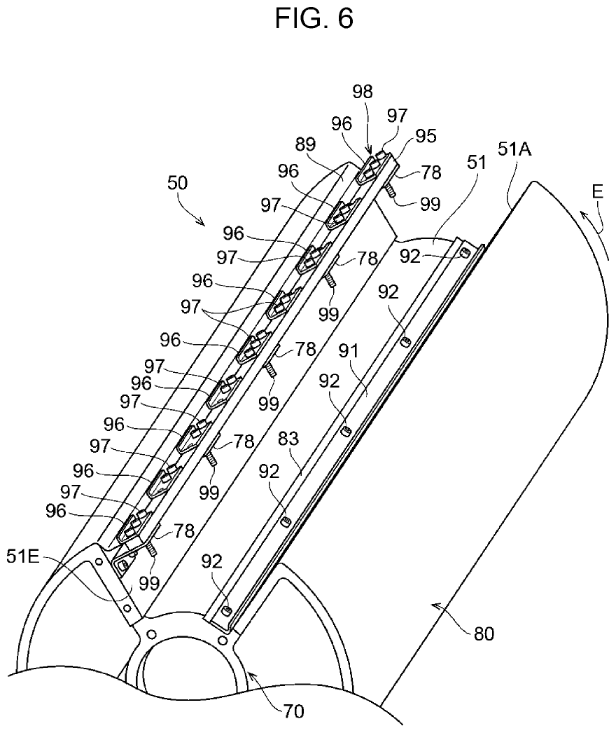

The drum body 70 is formed in a substantially cylindrical shape. As the drum body 70, for example, a metal material such as stainless steel or aluminum is used. The recessed portion 51 formed in the drum body 70 is provided in a part in the circumferential direction of the outer peripheral surface 70A of the drum body 70. As illustrated in FIG. 6, the recessed portion 51 is elongated along the axial direction of the drum body 70, and has a depth along the radial direction of the drum body 70.

The wound member 80 is formed in a sheet shape, as described above. The sheet shape is a shape such that, in a state in which the wound member 80 is wound around the drum body 70, the dimension along the radial direction of the drum body 70 (that is, thickness) is at least smaller than the dimension along the axial direction of the drum body 70 and the dimension along the circumferential direction of the drum body 70, the thickness allowing for curving along the outer peripheral surface 70A of the drum body 70. The sheet shape may also be referred to as a belt shape, a film shape, or a plate shape.

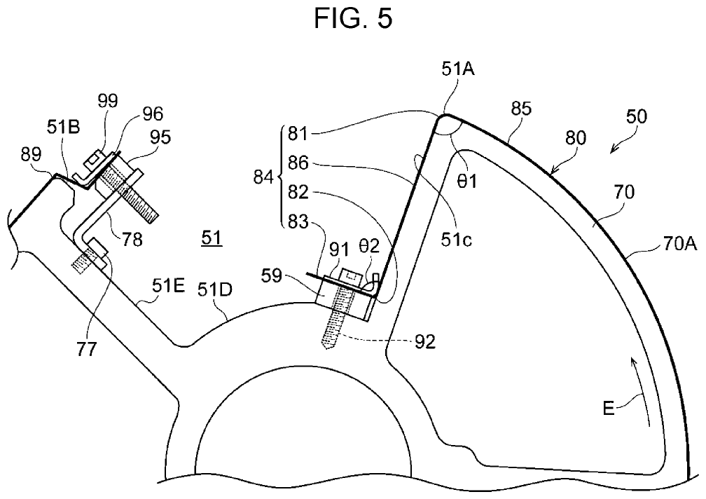

The wound member 80 is wound in a range of the outer peripheral surface 70A of the drum body 70 from a corner portion 51A (see FIG. 5) on the upstream side to a downstream end 51B (see FIG. 5) in the rotation direction E of the recessed portion 51. That is, the wound member 80 is wound around a part in the circumferential direction of the drum body 70.

In the exemplary embodiment, the wound member 80 in the state of being wound around the drum body 70 does not have an annular shape (i.e., a cylindrical shape) in which the end portion thereof on the upstream side and the end portion thereof on the downstream side in the rotation direction E are connected to each other. Instead, the wound member 80 in the wound state has a shape (a substantially C-shape in an axial view of the drum body 70) in which the end portion on the upstream side and the end portion on the downstream side in the rotation direction E are separated from each other.

Furthermore, the wound member 80 functions as a release layer that promotes peeling of the recording medium P, and is formed of a single layer. The wound member 80 is composed of, for example, a sheet material of glass cloth. The wound member 80 has a higher modulus of elasticity (Young's modulus) than the elastic layer 52B of the heating roller 52. The material of the wound member 80 is not limited to those described above, and various materials can be used. Unlike the heating roller 52, the fixing drum 50 includes only the wound member 80 as a release layer, and does not include an elastic layer.

As illustrated in FIG. 5, the wound member 80 is attached to the drum body 70 in a state in which a portion of the wound member 80 on the downstream side (hereinafter, referred to as a downstream-side portion 84) in the rotation direction E is bent radially inward of the drum body 70 at the corner portion 51A of the recessed portion 51.

The downstream-side portion 84 includes a first bent portion 81 that is bent radially inward of the drum body 70 at the corner portion 51A of the recessed portion 51; a second bent portion 82 that is bent on the radially inner side with respect to the first bent portion 81; and an attached portion 83 that is provided opposite the first bent portion 81 with respect to the second bent portion 82 and is attached to the drum body 70.

Here, the bent portions are each a corner portion that is formed by bending a part of the wound member 80, and is formed of two side portions forming sides in an axial view. The bent portions may be radiused (i.e., rounded).

The first bent portion 81 is a corner portion formed of a side portion 85 along the outer peripheral surface 70A of the drum body 70 and a side portion 86 along a side surface 51C on the upstream side in the rotation direction E of the recessed portion 51.

The second bent portion 82 is a corner portion formed of the side portion 86 along the side surface 51C of the recessed portion 51 and the attached portion 83 as a side portion along a bottom surface 51D on the radially inner side of the recessed portion 51.

The second bent portion 82 is bent, on the radially inner side of the first bent portion 81 (specifically, the radially inner side of the side portion 86), from a direction toward the radially inner side toward the downstream side in the rotation direction E.

Both the first bent portion 81 and the second bent portion 82 are bent at an acute angle. That is, of the angles formed by the side portion 85 and the side portion 86 constituting the first bent portion 81, the smaller angle θ1 (see FIG. 5) is an acute angle (that is, an angle less than 90 degrees). Further, of the angles formed by the side portion 86 and the attached portion 83 constituting the second bent portion 82, the smaller angle θ2 (see FIG. 5) is an acute angle (that is, an angle less than 90 degrees).

Further, the fixing drum 50 includes a restriction portion 91 that restricts extension of the second bent portion 82, and downstream-side attachment portions 92 that attach the attached portion 83 to the bottom surface 51D of the recessed portion 51.

The restriction portion 91 restricts extension of the second bent portion 82 by pinching the downstream-side portion 84 (specifically, the attached portion 83) between the restriction portion 91 and the drum body 70. Specifically, the restriction portion 91 is formed of a sheet metal that is formed in L-shape along the second bent portion 82 in an axial view of the drum body 70. That is, the restriction portion 91 is bent from the direction toward the radially inner side toward the downstream side in the rotation direction E. As illustrated in FIG. 6, the restriction portion 91 is disposed along the axial direction of the drum body 70, and has a length in the axial direction. The dimension of the restriction portion 91 along the axial direction is equal to or greater than the dimension of the wound member 80 along the axial direction.

As illustrated in FIG. 5, the drum body 70 includes a plate body 59. The attached portion 83 is pinched between the plate body 59 and the restriction portion 91. The dimension of the plate body 59 along the axial direction is equal to or greater than the dimension of the wound member 80 along the axial direction, and is equal to the dimension of the restriction portion 91 along the axial direction.

The downstream-side portion 84 is pinched between the restriction portion 91 and the side surface 51C of the recessed portion 51, and the downstream-side portion 84 (to be specific, the attached portion 83) is pinched between the restriction portion 91 and the radially outer surface of the plate body 59. Thus, extension of the second bent portion 82 is restricted.

Specifically, as illustrated in FIGS. 5 and 6, the downstream-side attachment portions 92 are composed of a plurality (five in FIG. 6) of screws arranged along the axial direction of the drum body 70. The downstream-side attachment portions 92 attach the attached portion 83 to the bottom surface 51D of the recessed portion 51 by screwing together the restriction portion 91 and the plate body 59 with the downstream-side portion 84 (specifically, the attached portion 83) pinched therebetween.

As illustrated in FIGS. 5 and 6, the fixing drum 50 further includes an upstream-side attachment portion 98 that attaches a portion of the wound member 80 on the upstream side in the rotation direction (hereinafter referred to as an upstream-side portion 89) to the drum body 70. The upstream-side attachment portion 98 is movable in a pulling direction in which the upstream-side portion 89 is pulled toward the upstream side in the rotation direction E. A plurality of upstream-side attachment portions 98 (specifically, adjustment members 99 to be described later) are arranged in the axial direction of the drum body 70.

Meanwhile, the drum body 70 has a body attachment portion 78 to which the upstream-side portion 89 is attached by the upstream-side attachment portions 98. Specifically, the body attachment portion 78 is formed of a sheet metal formed in L-shape in an axial view. A plurality (five in FIG. 6) of body attachment portions 78 are disposed at intervals along the axial direction of the drum body 70. In each of the plurality of body attachment portions 78, a portion forming one side of the L-shape is fixed to a side surface 51E of the recessed portion 51 on the downstream side in the rotation direction E by a fixing member 77 (for example, a screw). In each of the plurality of body attachment portions 78, a portion forming the other side of the L-shape is attached to a radially inner surface of a first attachment body 95 (to be described later) of the upstream-side attachment portion 98 by an adjustment member 99 (to be described later).

Specifically, the upstream-side attachment portions 98 each include the first attachment body 95, a second attachment body 96, attachment members 97, and the adjustment member 99. The first attachment body 95 and the second attachment body 96 are components to which the upstream portion 89 is attached. The first attachment body 95 is disposed along the axial direction of the drum body 70, and has a length in the axial direction. The dimension of the first attachment body 95 along the axial direction is equal to or greater than the dimension of the wound member 80 along the axial direction. The first attachment body 95 is formed in a plate shape with a thickness direction in the radial direction of the drum body 70.

The second attachment body 96 is formed of a sheet metal formed in L-shape in an axial view. A plurality (nine in FIG. 6) of second attachment bodies 96 are arranged at intervals along the axial direction of the drum body 70. In each of the plurality of second attachment bodies 96, a portion forming one side of the L-shape is disposed along a radially outer surface of the first attachment body 95, and the upstream-side portion 89 is pinched between the portion and the surface.

The attachment members 97 are members for attaching the upstream-side portion 89 to the first attachment body 95 and the second attachment bodies 96, and are composed of screws, for example. The attachment members 97 fix together the first attachment body 95 and the second attachment bodies 96 with the upstream-side portion 89 pinched therebetween, thereby attaching the upstream-side portion 89 to the first attachment body 95 and to the second attachment bodies 96.

The adjustment member 99 is a member that can adjust the tension of the wound member 80, and is composed of a screw, for example. As many adjustment members 99 as there are the body attachment portions 78 are provided. Each of the plurality of adjustment members 99 passes through the first attachment body 95 and the second attachment body 96, and is screwed into each of the plurality of body attachment portions 78.

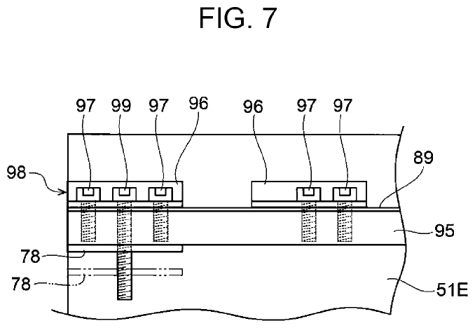

As illustrated in FIG. 7, by changing the amount of screwing with respect to the body attachment portion 78, the adjustment members 99 can be moved in the pulling direction in which the upstream-side portion 89 is pulled toward the upstream side in the rotation direction. That is, the adjustment members 99 can adjust the tension of the wound member 80 by changing the amount of screwing with respect to the body attachment portion 78. Note that in FIG. 7, the amount of screwing of the adjustment members 99 with respect to the body attachment portion 78 has been changed, where the body attachment portion 78 before the change is indicated by the two dot chain line, and the body attachment portion 78 after the change is indicated by the solid line. Further, the body attachment portion 78 indicated by the solid line is in the case where the amount of screwing is at the maximum.

Furthermore, in the exemplary embodiment, since the plurality of adjustment members 99 are arranged in the axial direction of the drum body 70, the tension of the wound member 80 can be adjusted at each portion in the axial direction.

### <Operation of Exemplary Embodiment>

In the fixing drum 50 according to the exemplary embodiment, the wound member 80 is attached to the drum body 70 in a state in which the downstream-side portion 84 is bent radially inward of the drum body 70 at the corner portion 51A of the recessed portion 51.

Therefore, compared to if the entire wound member 80 is wound in a state of extending only along the outer peripheral surface 70A of the drum body 70, the wound member 80 is less likely to be displaced with respect to the drum body 70 due to friction with the drum body 70, and loosening of the wound member 80 is suppressed, even when the fixing drum 50 rotates in the rotation direction E with the recording medium P pinched between the fixing drum 50 and the heating roller 52 to fix the toner image to the recording medium P.

The downstream-side portion 84 of the wound member 80 includes: the first bent portion 81 that is bent radially inward of the drum body 70 at the corner portion 51A of the recessed portion 51; the second bent portion 82 that is bent on the radially inner side with respect to the first bent portion 81; and the attached portion 83 that is disposed opposite the first bent portion 81 with respect to the second bent portion 82 and is attached to the drum body 70.

Therefore, compared to if the downstream-side portion 84 is bent at only one location, the wound member 80 is less likely to be displaced with respect to the drum body 70 due to friction with the drum body 70, and loosening of the wound member 80 is suppressed. As a result, image failure due to a fixing failure caused by the loosening of the wound member 80 is suppressed.

Further, in the exemplary embodiment, the second bent portion 82 is bent, on the radially inner side with respect to the first bent portion 81 (specifically, on the radially inner side of the side portion 86), from the direction toward the radially inner side toward the downstream side in the rotation direction E.

Therefore, compared to if the second bent portion 82 is bent, on the radially inner side with respect to the first bent portion 81, from the direction toward the radially inner side toward the upstream side in the rotation direction, the attached portion 83 is exposed on the radial side (i.e., the opening side) with respect to the recessed portion 51, so that the attached portion 83 can be easily attached to the drum body 70.

In addition, in the exemplary embodiment, the restriction portion 91 restricts extension of the second bent portion 82 by pinching the downstream-side portion 84 (specifically, the attached portion 83) between the restriction portion 91 and the drum body 70.

Accordingly, compared to if the second bending portion 82 is freely extendable, the state in which the wound member 80 is in contact with the drum body 70 is maintained, and loosening of the wound member 80 is suppressed.

Furthermore, in the exemplary embodiment, the downstream-side attachment portions 92 attach the attached portion 83 of the downstream-side portion 84 of the wound member 80 to the bottom surface 51D of the recessed portion 51.

Therefore, the downstream-side attachment portions 92 are less likely to interfere with other members (for example, the grippers 60 accommodated in the recessed portion 51) than if the downstream-side attachment portions 92 attach the attached portion 83 to the drum body 70 on the radially outer side with respect to the bottom surface 51D of the recessed portion 51.

Both the first bent portion 81 and the second bent portion 82 are bent at an acute angle. Accordingly, compared to if only one of the first bent portion 81 and the second bent portion 82 is bent at an acute angle, the wound member 80 is less likely to be displaced to the upstream side in the rotation direction E, and loosening of the wound member 80 is suppressed.

The upstream-side attachment portions 98 that attach the upstream-side portion 89 of the wound member 80 to the drum body 70 can be moved in the pulling direction in which the upstream-side portion 89 is pulled toward the upstream side in the rotating direction. Therefore, compared to if the upstream-side attachment portions 98 are fixed, the wound member 80 can be pulled toward the upstream side in the rotation direction so that the loosening of the wound member 80 is suppressed.

In the exemplary embodiment, a plurality of upstream-side attachment portions 98 are arranged in the axial direction of the drum body 70. Accordingly, compared to if the upstream-side attachment portions 98 are disposed at only one location in the axial direction, loosening of the wound member 80 is suppressed when the outer diameter of the drum body 70 varies in the axial direction.

### <Modifications>

In the exemplary embodiment, the downstream-side portion 84 of the wound member 80 has the first bent portion 81 and the second bent portion 82. However, this is not a limitation. For example, the downstream-side portion 84 may be configured to have only the first bent portion 81. That is, the downstream-side portion 84 may be configured to be bent at only one location.

Furthermore, in the exemplary embodiment, the second bent portion 82 is bent, on the radially inner side with respect to the first bent portion 81 (specifically, on the radially inner side at the side portion 86), from the direction toward the radially inner side toward the downstream side in the rotation direction E. However, this is not a limitation. For example, the second bent portion 82 may be configured to be bent, on the radially inner side with respect to the first bent portion 81, from the direction toward the radially inner side toward the upstream side in the rotation direction.

In the exemplary embodiment, the restriction portion 91 restricts extension of the second bent portion 82 by pinching the downstream-side portion 84 (specifically, the attached portion 83) between the restriction portion 91 and the drum body 70. However, this is not a limitation. For example, the second bent portion 82 of the downstream-side portion 84 may be configured to be freely extendable.

Further, in the exemplary embodiment, the downstream-side attachment portions 92 attach the attached portion 83 of the downstream-side portion 84 of the wound member 80 to the bottom surface 51D of the recessed portion 51. However, this is not a limitation. For example, the downstream-side attachment portions 92 may be configured to attach the attached portion 83 to the drum body 70 on the radially outer side with respect to the bottom surface 51D of the recessed portion 51.

In the exemplary embodiment, both the first bent portion 81 and the second bent portion 82 are bent at an acute angle. However, this is not a limitation. For example, only one of the first bent portion 81 and the second bent portion 82 may be configured to be bent at an acute angle. That is, in the exemplary embodiment, at least one of the first bent portion 81 and the second bent portion 82 may be bent at an acute angle.

According to the configuration in which at least one of the first bent portion 81 and the second bent portion 82 is bent at an acute angle, compared to if both of the first bent portion 81 and the second bent portion 82 are bent at an angle of 90 degrees or more, the wound member 80 is less likely to be displaced toward the upstream side in the rotation direction E, and loosening of the wound member 80 is suppressed.

In the exemplary embodiment, the upstream-side attachment portions 98 that attach the upstream-side portion 89 of the wound member 80 to the drum body 70 are movable in the pulling direction in which the upstream-side portion 89 is pulled toward the upstream side in the rotation direction. However, this is not a limitation. For example, the upstream-side attachment portions 98 may be configured to be fixed (configured to be immovable).

Further, in the exemplary embodiment, a plurality of upstream-side attachment portions 98 are arranged in the axial direction of the drum body 70. However, this is not a limitation. The upstream-side attachment portions 98 may be configured to be disposed at only one location in the axial direction.

The present invention is not limited to the above-described exemplary embodiments, and various modifications, changes, and improvements can be made without departing from the spirit of the present invention. For example, a plurality of modifications described above may be appropriately combined.

### APPENDIX

(((1)))

A fixing device comprising:
a fixing roller; and
a fixing drum that rotates in a rotation direction with a recording medium having an image formed thereon pinched between the fixing roller and the fixing drum, to fix the image onto the recording medium,
   wherein the fixing drum includes:
a drum body having a recessed portion formed on an outer peripheral surface thereof, and
a sheet-like wound member that is wound around the outer peripheral surface and is attached to the drum body in a state in which a portion of the wound member on a downstream side in the rotation direction is bent radially inward of the drum body at a corner portion of the recessed portion.

(((2)))

The fixing device according to (((1))), wherein the portion on the downstream side in the rotation direction includes:
a first bent portion that is bent radially inward of the drum body at the corner portion of the recessed portion;
a second bent portion that is bent on a radially inner side with respect to the first bent portion; and
an attached portion that is provided on a side opposite to the first bent portion with respect to the second bent portion, and is attached to the drum body.

(((3)))

The fixing device according to (((2))), wherein the second bent portion is bent, on the radially inner side with respect to the first bent portion, from a direction toward the radially inner side toward the downstream side in the rotation direction.

(((4)))

The fixing device according to (((3))), comprising a restriction portion that restricts extension of the second bent portion by pinching the portion on the downstream side in the rotation direction between the restriction portion and the drum body.

(((5)))

The fixing device according to (((3))) or (((4))), comprising a downstream-side attachment portion that attaches the attached portion to a bottom surface on the radially inner side of the recessed portion.

(((6)))

The fixing device according to any one of (((2))) to ((((5))), wherein at least one of the first bent portion and the second bent portion is bent at an acute angle.

(((7)))

The fixing device according to (((6))), wherein both of the first bent portion and the second bent portion are bent at an acute angle.

(((8)))

The fixing device according to any one of (((1))) to (((7))), further comprising an upstream-side attachment portion that attaches a portion on the upstream side in the rotation direction of the wound member to the drum body, and is movable in a pulling direction in which the portion on the upstream side in the rotation direction is pulled toward the upstream side in the rotation direction.

(((9)))

The fixing device according to (((8))), wherein a plurality of the upstream-side attachment portions are arranged in an axial direction of the drum body.

(((10)))

An image forming apparatus comprising:
a transfer device that transfers an image onto a recording medium; and
the fixing device according to any one of (((1))) to (((9))) that fixes the image transferred onto the recording medium by the transfer device to the recording medium.

What is claimed is:

1. A fixing device comprising:
a fixing roller; and
a fixing drum that rotates in a rotation direction with a recording medium having an image formed thereon pinched between the fixing roller and the fixing drum, to fix the image onto the recording drum,
the fixing drum including:
a drum body having a recessed portion formed on an outer peripheral surface thereof, and
a sheet-shaped wound member that is wound around the outer peripheral surface and is attached to the drum body in a state in which a portion of the wound member on a downstream side in the rotation direction is bent radially inward of the drum body at a corner portion of the recessed portion.

2. The fixing device according to claim 1, wherein the portion on the downstream side in the rotation direction includes:
a first bent portion that is bent radially inward of the drum body at the corner portion of the recessed portion;
a second bent portion that is bent on a radially inner side with respect to the first bent portion; and
an attached portion that is provided on a side opposite to the first bent portion with respect to the second bent portion, and is attached to the drum body.

3. The fixing device according to claim 2, wherein the second bent portion is bent, on the radially inner side with respect to the first bent portion, from a direction toward the radially inner side toward the downstream side in the rotation direction.

4. The fixing device according to claim 3, further comprising a restriction portion that restricts extension of the second bent portion by pinching the portion on the downstream side in the rotation direction between the restriction portion and the drum body.

5. The fixing device according to claim 3, further comprising a downstream-side attachment portion that attaches the attached portion to a bottom surface on the radially inner side of the recessed portion.

6. The fixing device according to claim 2, wherein at least one of the first bent portion and the second bent portion is bent at an acute angle.

7. The fixing device according to claim 6, wherein both of the first bent portion and the second bent portion are bent at an acute angle.

8. The fixing device according to claim 1, further comprising an upstream-side attachment portion that attaches a portion of the wound member on an upstream side in the rotation direction to the drum body, and is movable in a pulling direction in which the portion on the upstream side in the rotation direction is pulled toward the upstream side in the rotation direction.

9. The fixing device according to claim 8, wherein a plurality of the upstream-side attachment portions are arranged in an axial direction of the drum body.

10. An image forming apparatus comprising:
a transfer device that transfers an image onto a recording medium; and
the fixing device according to claim 1 that fixes the image transferred onto the recording medium by the transfer device to the recording medium.

11. An image forming apparatus comprising:
a transfer device that transfers an image onto a recording medium; and
the fixing device according to claim 2 that fixes the image transferred onto the recording medium by the transfer device to the recording medium.

12. An image forming apparatus comprising:
a transfer device that transfers an image onto a recording medium; and
the fixing device according to claim 3 that fixes the image transferred onto the recording medium by the transfer device to the recording medium.

13. An image forming apparatus comprising:
a transfer device that transfers an image onto a recording medium; and
the fixing device according to claim 4 that fixes the image transferred onto the recording medium by the transfer device to the recording medium.

14. An image forming apparatus comprising:
a transfer device that transfers an image onto a recording medium; and
the fixing device according to claim 5 that fixes the image transferred onto the recording medium by the transfer device to the recording medium.

15. An image forming apparatus comprising:
a transfer device that transfers an image onto a recording medium; and
the fixing device according to claim 6 that fixes the image transferred onto the recording medium by the transfer device to the recording medium.

16. An image forming apparatus comprising:
a transfer device that transfers an image onto a recording medium; and
the fixing device according to claim 7 that fixes the image transferred onto the recording medium by the transfer device to the recording medium.

17. An image forming apparatus comprising:
a transfer device that transfers an image onto a recording medium; and
the fixing device according to claim 8 that fixes the image transferred onto the recording medium by the transfer device to the recording medium.

18. An image forming apparatus comprising:
a transfer device that transfers an image onto a recording medium; and
the fixing device according to claim 9 that fixes the image transferred onto the recording medium by the transfer device, to the recording medium.
